(19) United States
(12) Patent Application Publication
(10) Pub. No.: US 2019/0316487 A1
(43) Pub. Date: Oct. 17, 2019

(54) Non-Concentric Turbine Housing

(71) Applicant: Novatek IP, LLC, Provo, UT (US)

(72) Inventor: Scott Dahlgren, Alpine, UT (US)

(21) Appl. No.: 15/954,882

(22) Filed: Apr. 17, 2018

(51) Int. Cl. F01D 25/16; F01D 9/04; F01D 5/14; F01D 25/24

(52) U.S. Cl. CPC F01D 25/16; F01D 9/041; F05D 2220/30; F01D 25/24; F01D 5/141

(57) ABSTRACT

A turbine transducer, capable of passing fluid comprising significant solids therein while maintaining a substantially linear relationship between flow and rotation, may comprise an axial turbine only partially exposed to a fluid flow. Specifically, a turbine, comprising a plurality of blades extending radially from a hub, may rotate around a bearing axle positioned parallel to, but offset from, a central axis of a flow bore. Fluid may flow through the flow bore and past the turbine blades. The flow bore may be formed in a housing that holds the turbine in place.

### BACKGROUND

A turbine is a type of transducer capable of converting kinetic energy from a flowing fluid in to mechanical energy of a rotating rotor. A great variety of turbines exist and are used for a range of purposes, such as measuring a parameter of the fluid flow or converting the rotational energy into useful work. Some turbines, known as axial turbines, rotate about an axis parallel to the direction of fluid flow. Others, known as tangential turbines, rotate about an axis when fluid tangent to the axis impacts the turbine.

When fluid is traveling through a bore, axial turbines are typically positioned concentrically with the bore such that a majority of the fluid is forced through the turbine. This generally leads to maximum energy conversion and a substantially linear relationship between flow and rotation. This linear relationship may be important for accurate flow measurement across an assortment of fluids and flow rates. Such a configuration may cause problems, however, if solids are traveling with the fluid. In these situations, the solids may get caught on the turbine slowing its rotation or jamming it completely which may disrupt its linearity.

A tangential turbine, with a rotational axis positioned outside of a flow bore may allow solids to pass more easily. However, linearity may suffer even more than with a comparable axial turbine due to viscous boundary considerations. Additionally, turbines impacted by fluid flowing tangent to the axis thereof may wear prematurely when that fluid comprises solids traveling therewith. Turndown ratio, which indicates a range of flow that a turbine is able to measure with acceptable accuracy, may decrease significantly as well.

### BRIEF DESCRIPTION

A turbine transducer, capable of passing fluids comprising significant solids therein while maintaining a substantially linear relationship between flow and rotation, may comprise an axial turbine only partially exposed to a fluid flow. Specifically, a turbine, comprising a plurality of blades extending radially from a hub, may rotate around a bearing axle positioned parallel to, but offset from, a central axis of a flow bore. Fluid may flow through the flow bore and past the turbine blades.

The flow bore may be formed in a housing that holds the turbine in place. In various embodiments, this housing may also comprise an internal wall spaced radially from the turbine so as to limit unwanted pumping of the turbine. The internal wall of the housing may form a cavity adjacent the turbine and opposite from the flow bore. This cavity may comprise an axis planar with and set at an angle from the central axis of the flow bore.

To maintain substantial linearity between the flow rate and rotation speed, the bearings of the turbine may be protected from the flow and provide minimal resistance. In some embodiments, these objectives may be accomplished by attaching the bearing axle to the housing at only one end thereof opposite from an origin of the flow. Additionally, the bearing axle may comprise a cylinder rotatable relative to both the turbine and the housing.

To easily allow solids to pass the turbine, the turbine blades may be tapered toward a first end of the bearing. A matching flow straightener, comprising multiple blades protruding from the housing into the flow bore, may also aid in allowing solids to pass unobstructed while improving linearity.

### DRAWINGS

FIG. 1 is a longitude-sectional view of an embodiment of a flow meter.

FIG. 2 is a perspective view of an embodiment of a turbine.

FIG. 3 is an orthogonal view of an embodiment of a flow straightener.

FIG. 4 is a partially-cutaway perspective view of an embodiment of a bearing axle.

### DETAILED DESCRIPTION

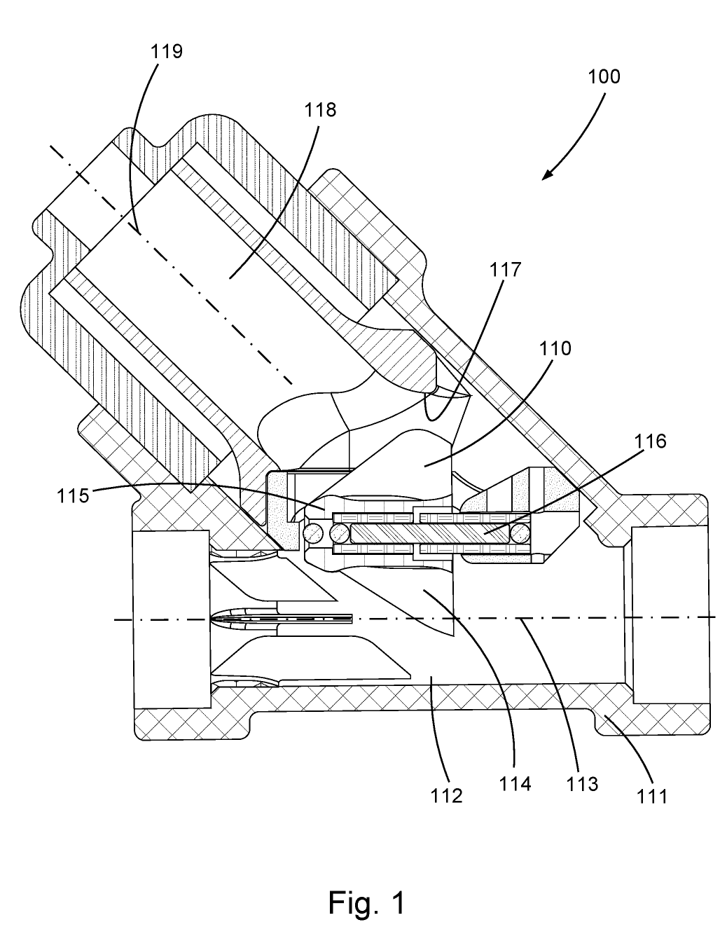

Referring now to the figures, FIG. 1 shows an embodiment of a flow meter 100, (although a generator or other comparable device may appear similar) comprising a turbine 110 disposed within a housing 111. The housing 111 may comprise a flow bore 112 passing therethrough. As shown, the flow bore 112 comprises a generally tubular shape centered around a straight central axis 113, although other geometries and configurations are anticipated. The turbine 110 may comprise a plurality of blades 114 extending radially from a hub 115. The hub 115 may be rotatable around a bearing axle 116 positioned parallel to the central axis 113 of the flow bore 112. In the embodiment shown, the bearing axle 116 is positioned outside of the flow bore 112 such that the blades 114 of the turbine 110 are only partially exposed to fluid flowing through the flow bore 112. To maximize the power transfer, an exterior of the bearing axle 116 may be situated against an exterior of the flow bore 112.

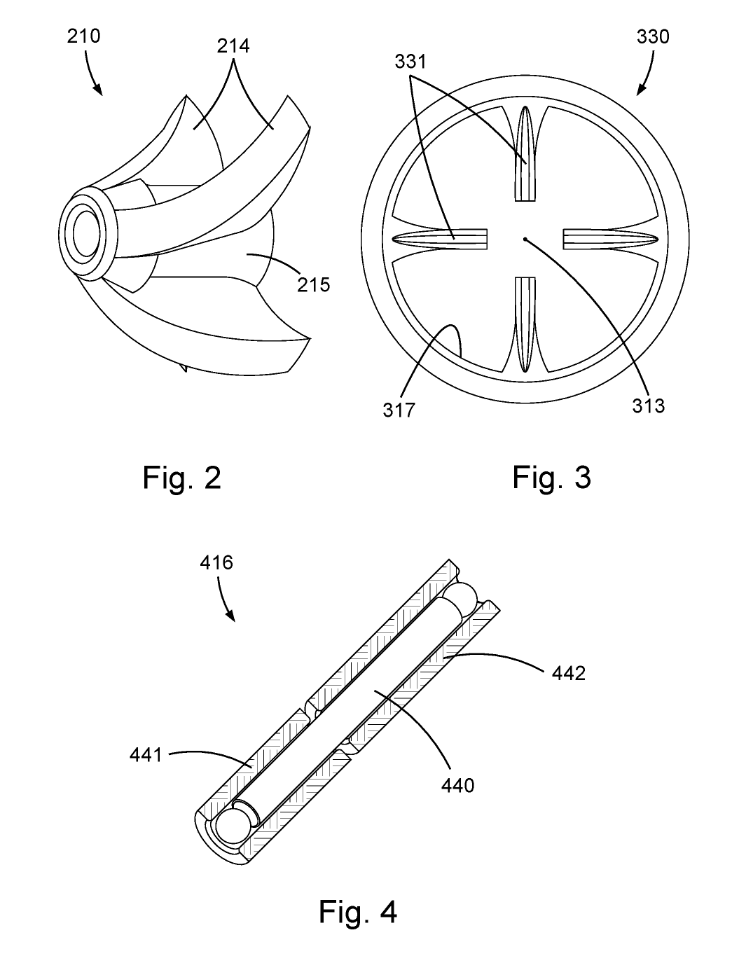

FIG. 2 shows an embodiment of a turbine 210 comprising a plurality of blades 214 each extending radially from a hub 215 thereof and curving tangentially thereabout. Such a turbine may rotate at a substantially linear relationship with a flow rate through an adjacent flow bore.

Each of the blades 214 may taper towards the hub 215 at a leading end of the turbine 210. This leading end may face the origin of a fluid flow such that solids may pass the blades 214 without hindering rotation of the turbine 210. In the embodiment shown, the blades 214 taper at an angle of 30° to 45° from a rotational axis of the turbine 210. It was found that smaller angles may not shed solids off of the blades 214 as well while larger angles could lead to non-linearity and reduced turndown ratios, presumably due to vortex shedding off of leading edges of blades.

This turbine 210 may comprise a relatively high turndown ratio (defined as a ratio of flow that is able to be measured accurately) of over 8:1 compared to analogous concentrically-positioned axial turbines. For instance, the embodiment shown may comprise a maximum flow of over 365 gallons per minute (0.0230 cubic meters per second) and a minimum flow of under 45 gallons per minute (0.0028 cubic meters per second).

FIG. 3 shows an embodiment of a flow straightener 330 that may form part of a housing as described above. The flow straightner 330 may comprise multiple blades 331 protruding from an internal wall 317 of a flow bore of such a housing. These blades 331 may reduce vortexes from forming in fluid passing through the flow bore and thus improve linearity. In the embodiment shown, each of the blades 331 shares a plane with a central axis 313 of the flow bore. Further, each of the blades 331 may taper away from the central axis 313 with a geometry matching that of blades of an associated turbine. It was found that such a matching geometry between a flow straightener and a turbine may aid in shedding solids from the turbine.

It was found that maintaining linearity between fluid flow rate and turbine rotational velocity was aided by reducing bearing resistance. Keeping bearing resistance low may become more challenging when solids are introduced into a fluid flow, especially if they are able to infiltrate into the bearing mechanics. FIG. 4 shows an embodiment of a bearing axle 416. Unlike previously known bearing axles used for concentrically positioned axial turbines which are attached on both ends thereof, the bearing axle 416 may be attached to a housing on only one end thereof facing away from an origin of the fluid. It is believed that this configuration inhibits fluid-borne solids from infiltrating the bearing axle 416 and may pull out material from the one attachment end as the fluid passes. It may also simplify manufacturing in that it does not require aligning two bearings. Not needing to align bearings may further allow for tighter clearances, more resistant to infiltration.

Having only one attachment end, however, may increase the friction experienced by that end. The bearing axle 416 shown comprises a cylinder 440 held within two tubes. A first tube 441 may be rotationally fixed to a turbine while a second tube 442 may be rotationally fixed to a housing. This may create two possible bearing surfaces. In this configuration, the average velocity experienced by each bearing surface may be half of what it would be if there were only one bearing surface. As drag may increase with the square of velocity, the drag may be one-quarter of that experienced by a single bearing surface. In addition, having two independent bearing surfaces may allow a turbine to continue rotating even if one freezes for some reason, thus providing an extra layer of safety.

Referring back to FIG. 1, the housing 111 may comprise an internal wall 117 spaced radially from the turbine 110. This spacing may allow the turbine 110 to perform similarly to an unducted turbine in the sense that radial pumping pressure from the turbine 110 may not hamper rotation. This spacing may also reduce the chance of pack-off of material between the turbine 110 and the internal wall 117. Designing a turbine with a low aspect ratio (defined as a ratio of a turbine blade's tip length to its root length) planform may also reduce pumping pressure.

The internal wall 117 may also form a cavity 118 adjacent the turbine 110 on an opposite side of the turbine 110 from the flow bore 112. It is believed that this cavity 118 may provide space for fluid expelled from the turbine 110 to go without disrupting fluid flow through the flow bore 112. The cavity 118 may comprise a generally tubular shape with a cross-sectional area substantially similar to a cross-sectional area of the flow bore 112. The cavity 118 may comprise a cavity axis 119 positioned in a similar plane with the central axis 113 of the flow bore 112. The cavity axis 119 may be tilted toward an origin of flow through the flow bore 112 at an angle less than 80° from the central axis 113 (in the embodiment shown, this tilt angle is 45%). This tilting may allow solids within the cavity 119 to exit therefrom, due to motion of fluid flowing through the flow bore 112, without getting dynamically trapped therein.

The housing 111 may also provide sufficient room between the interior wall 117 and the turbine 110, on an end of the turbine 110 facing a destination of the fluid. This open back may allow fluid to flow from the turbine 110 back to the flow bore 112 without adding excessive turbulence thereto.

Whereas the present invention has been described in particular relation to the drawings attached hereto, it should be understood that other and further modifications apart from those shown or suggested herein, may be made within the scope and spirit of the present invention.

1. A transducer assembly, comprising:
a housing comprising a flow bore, with a central axis, passing therethrough; and
a turbine, comprising a plurality of blades extending radially from a hub, rotatable around a bearing axle positioned parallel to the flow bore central axis; wherein
the turbine is only partially exposed to the flow bore.

2. The transducer assembly of claim 1, wherein the bearing axle is positioned outside of the flow bore.

3. The transducer assembly of claim 2, wherein an exterior of the bearing axle is positioned substantially on an exterior of the flow bore.

4. The transducer assembly of claim 1, wherein the plurality of blades are tapered toward a first end of the bearing axle.

5. The transducer assembly of claim 4, wherein the plurality of blades are tapered at an angle of 30° to 45° from the bearing axle.

6. The transducer assembly of claim 1, wherein each of the plurality of blades are curved about the bearing axle.

7. The transducer assembly of claim 1, further comprising a flow straightener, comprising multiple blades protruding from the housing into the flow bore, each of the multiple blades sharing a plane with the flow bore central axis.

8. The transducer assembly of claim 7, wherein the flow straightener multiple blades are tapered away from the central axis of the flow bore.

9. The transducer assembly of claim 7, wherein the flow straightener multiple blades are shaped to match a geometry of the plurality of blades.

10. The transducer assembly of claim 1, wherein the bearing axle is attached to the housing on only a second end of the bearing axle.

11. The transducer assembly of claim 1, wherein the bearing axle comprises a cylinder rotatable relative to the turbine and the housing.

12. The transducer assembly of claim 1, wherein the housing comprises an internal wall spaced radially from the turbine.

13. The transducer assembly of claim 1, wherein the housing comprises an internal wall forming a cavity adjacent the turbine opposite from the flow bore.

14. The transducer assembly of claim 13, wherein the cavity comprises a cavity axis that shares a plane with the flow bore central axis.

15. The transducer assembly of claim 14, wherein the cavity axis is disposed at an angle less than 80° from the flow bore central axis.

16. The transducer assembly of claim 15, wherein the cavity axis is tilted toward an origin of flow through the flow bore.

17. The transducer assembly of claim 13, wherein the cavity comprises a cross-sectional area substantially similar to a cross-sectional area of the flow bore.

18. The transducer assembly of claim 1, wherein the turbine rotates in a substantially linear relationship with a flow rate through the flow bore.

19. The transducer assembly of claim 1, comprising a turndown ratio of over 8:1.

20. The transducer assembly of claim 1, comprising a maximum flow of over 365 gallons per minute (0.0230 cubic meters per second) and a minimum flow of under 45 gallons per minute (0.0028 cubic meters per second).
